(19) United States
(12) Patent Application Publication
(10) Pub. No.: US 2025/0092970 A1
(43) Pub. Date: Mar. 20, 2025

(54) JOINT FOR PLASTIC LINED CONCRETE PIPE

(71) Applicant: Tony DIMILLO, Newmarket (CA)

(72) Inventor: Tony DIMILLO, Newmarket (CA)

(21) Appl. No.: 18/889,976

(22) Filed: Sep. 19, 2024

Related U.S. Application Data
(60) Provisional application No. 63/584,082, filed on Sep. 20, 2023.

(51) Int. Cl. F16L 21/02

(52) U.S. Cl. CPC F16L 21/02

(57) ABSTRACT

Provided herein is a joint for plastic lined concrete pipe. The joint may include an end-to-end connection between a bell, or socket end of a first segment of plastic lined concrete pipe, and a spigot, or tip end of a second segment of plastic lined concrete pipe. The opposing end faces of the bell and spigot ends may be held together by a conventional clamping mechanism, as discussed in greater detail below. The end faces may each be covered by a thermoplastic material, such as high density polyethylene (“HDPE”). A circumferential seal, such as a packer, may be retained between the end faces. The circumferential packer, alone or in combination with a circumferential block seal positioned radially outwardly therefrom, may reduce or prevent fluid flowing through the pipe from escaping as the fluid flows through the joint.

### CROSS-REFERENCES TO RELATED APPLICATIONS

This application claims the benefit of priority to U.S. Provisional Application Ser. No. 63/584,082 filed Sep. 20, 2023, the content of which is incorporated herein by reference in its entirety.

### TECHNICAL FIELD

The following generally relates to joints for lined pipes, particularly plastic lined concrete pipes.

### BACKGROUND

Plastic lined concrete pipes are widely used in water management systems, such as sanitation systems, culverts and storm drains. In sanitation, or sewage systems, for example, the inner plastic liner may serve to prevent or reduce contact between wastewater and the concrete pipe and thus mitigate corrosion of the pipes.

However, concrete lined concrete pipes often suffer from fluid leakage into the space between opposing outer pipe end faces within pipe joints. Such leakage is often caused by a poor or compromised seal, and can lead to corrosion of the concrete at the joint and eventually failure of the pipe.

Attempts have been made to reduce corrosion of concrete in the joint, such as by applying heat to inner thermoplastic liners and shaping them to extend radially outwardly to cover the end faces of the bell and spigot ends (i.e., to create sealing flanges). Forming such sealing flanges may disadvantageously require considerable manufacturing effort. For example, deformation properties of the thermoplastic material in use must be taken into account to determine the minimum radii of liner curvature for formation of sealing flanges, imposing constraints on possible cross-sectional flow areas.

Further, methods of installing plastic lined concrete pipes typically involve welding the pipes together at each joint, which can incur considerable installation costs.

In view of the foregoing, it is desirable to develop an improved joint for plastic lined concrete pipes.

### SUMMARY

Provided herein is a joint for plastic lined concrete pipe. The joint may include an end-to-end connection between a bell, or socket end of a first segment of plastic lined concrete pipe, and a spigot, or tip end of a second segment of plastic lined concrete pipe. The opposing end faces of the bell and spigot ends may be held together by a conventional clamping mechanism, as discussed in greater detail below. The end faces may each be covered by a thermoplastic material, such as high density polyethylene (“HDPE”). A circumferential seal, such as a packer, may be retained between the end faces. The circumferential packer, alone or in combination with a circumferential block seal positioned radially outwardly therefrom, may reduce or prevent fluid flowing through the pipe from escaping as the fluid flows through the joint.

In one aspect, there is provided a joint assembly for a plastic lined concrete pipe, the assembly comprising: a first pipe having a first interior lining; a second pipe having a second interior lining, the first and second interior linings being for conveying a fluid through the first and second pipes, respectively; a first circumferential end cover provided on and at least partially covering an end face at a spigot end of the first pipe; a second circumferential end cover provided on and at least partially covering an end face at a bell end of the second pipe; a bell at the bell end; a spigot at the spigot end; and the spigot being engageable by the bell end to couple the spigot end to the bell end and to retain a first circumferential seal between the end faces.

In an implementation, the end faces are perpendicular to longitudinal axes defined by their respective pipes.

In another implementation, the joint assembly further comprises a second circumferential seal sized to be provided between the end faces and having an inner diameter larger than an outer diameter of the first circumferential seal.

In yet another implementation, the first and second circumferential end covers are made from a thermoplastic material.

In yet another implementation, the first and second interior linings are made from a thermoplastic material.

In yet another implementation, the thermoplastic material comprises high density polyethylene.

In yet another implementation, the end covers and interior linings are made from the same material.

In yet another implementation, the end covers are welded to the end faces.

### BRIEF DESCRIPTION OF THE DRAWINGS

Embodiments will now be described with reference to the appended drawings wherein:

FIG. 1 is a perspective view of a concrete lined pipe segment.

FIG. 2 is a cross-sectional view of the concrete lined pipe segment.

FIG. 3 is a top view of the concrete lined pipe segment.

FIG. 4 is a cross-sectional side view of the concrete lined pipe segment.

FIG. 5 is an expanded view of a section of the spigot end of the concrete lined pipe segment shown in FIG. 4.

FIG. 6 is an expanded view of a section of the bell end of the concrete lined pipe segment shown in FIG. 4.

FIG. 7 is a side cross-sectional expanded view of a joint connecting two concrete lined pipe segments.

### DETAILED DESCRIPTION

One or more of the terms “vertical”, “vertically”, “horizontal”, “horizontally”, “top”, “bottom”, “upwardly”, “downwardly”, “upper”, “lower”, “front”, “back”, “outwardly” and “inwardly” are used throughout this specification. It will be understood that these terms are not intended to be limiting. These terms are used for convenience and to aid in describing the features herein, for instance, as illustrated in the accompanying drawings.

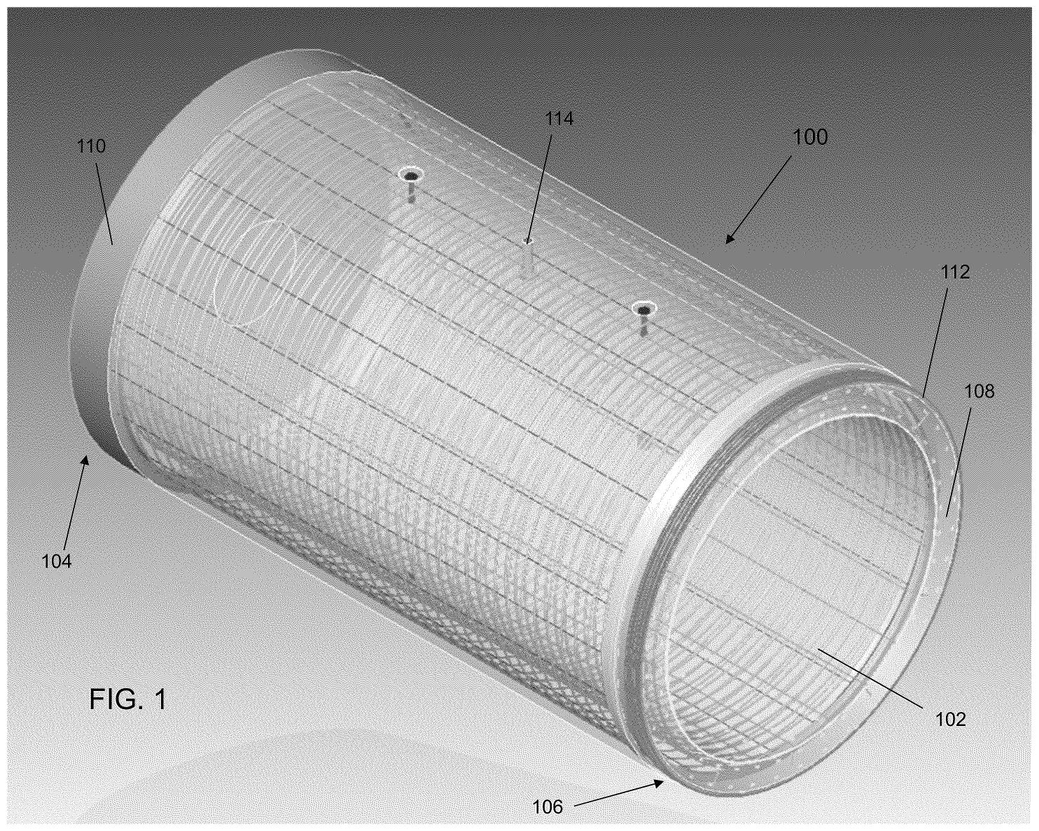

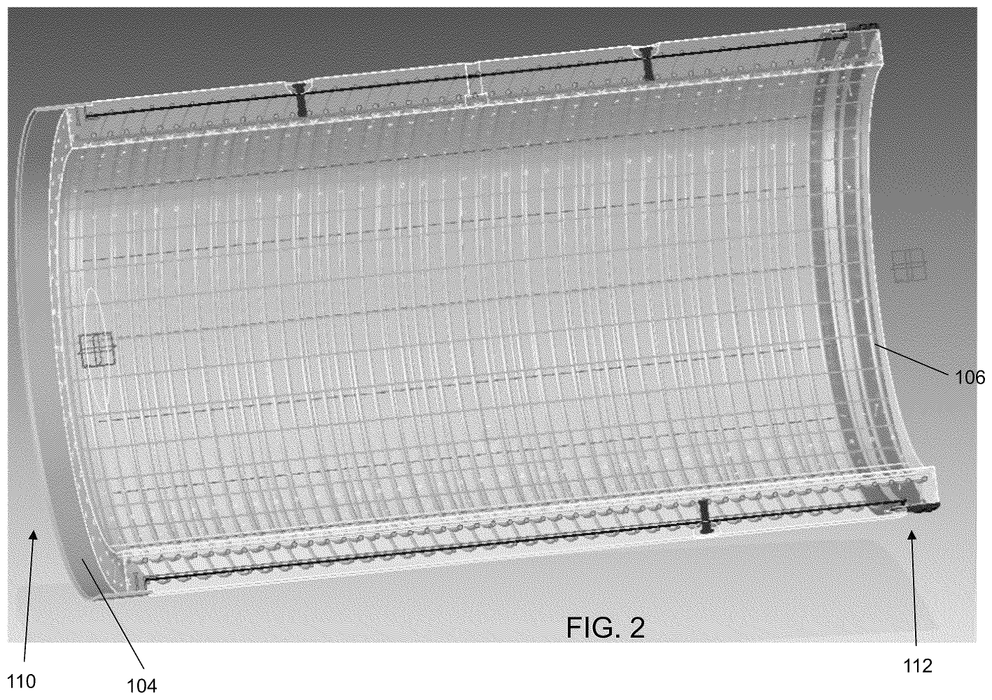

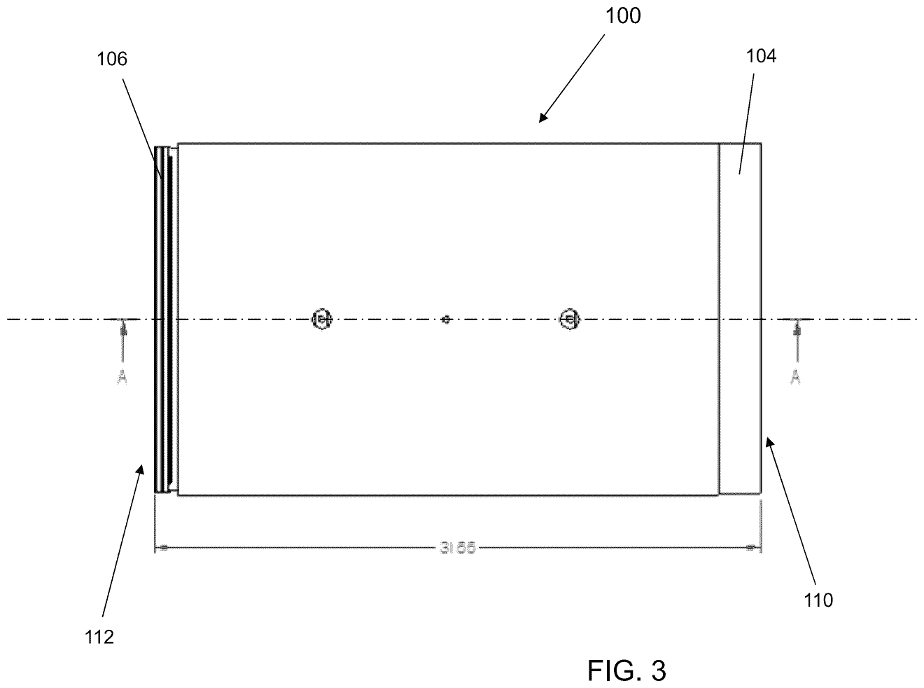

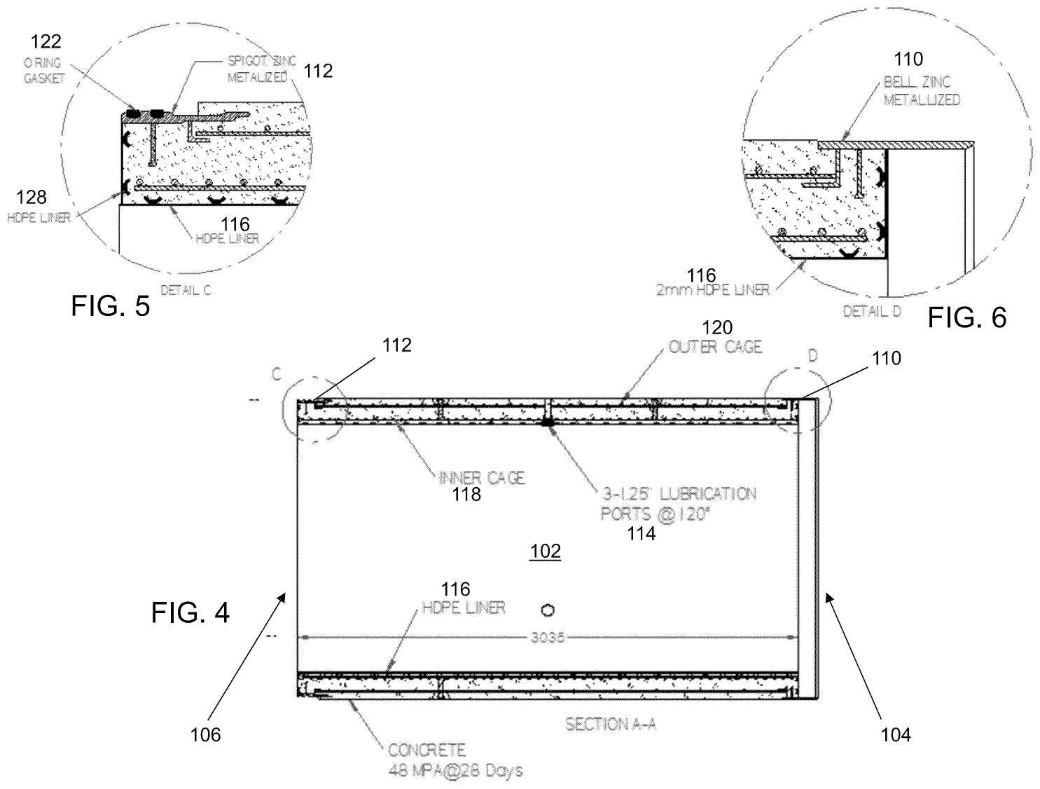

FIGS. 1-4 illustrate a plastic lined concrete pipe section 100 for use in a joint assembly according to the present disclosure. The pipe section 100 may include an inner plastic lining 116 (as clearly shown in FIGS. 4-7) having a bore, or fluid passageway 102 defined therein. The plastic lining 102 may be made from a suitable thermoplastic material such as, for example, HDPE. The pipe section 100 may optionally include at least one lubrication port 114. The at least one lubrication port 114 may allow for grouting of the tunnel (not shown) once the pipe section 100 is in place therein.

The pipe section 100 may comprise a first, or bell end 104, and a second, or spigot end 106. As seen most clearly in FIGS. 4-6, the bell and spigot ends 104, 106 may include a bell 110 and a spigot 112, respectively. The bell and spigot 110, 112 may be made from any suitable material. In this example embodiment, the bell and spigot 110, 112 are steel and include a metallized zinc coating. The pipe section 100 may include one or more reinforcing cages encased in the concrete (e.g. inner and outer cages 118, 120).

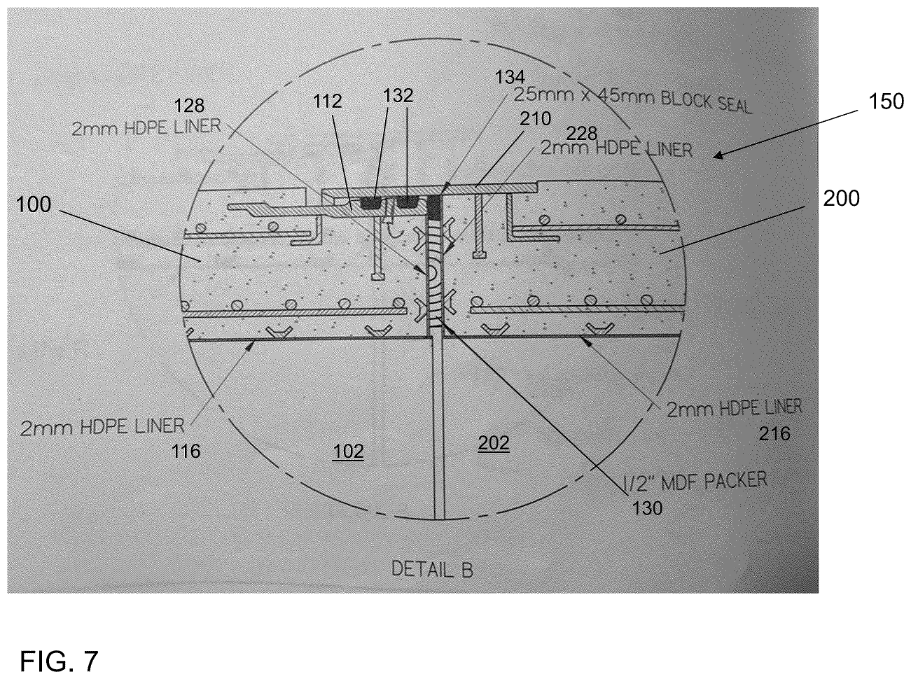

The spigot 112 may include one or more gaskets, such as O rings (see FIG. 5). Turning to FIG. 7, illustrated is a joint assembly 150 including the pipe segment 100 and another pipe segment 200. The pipe segment 200 may include features similar to the pipe segment 100, and thus like features include the same reference characters except for having replaced the prefix “1” with “2”. The HDPE liners may have a thickness of, for example, 2 mm as shown in FIG. 7; however, the liners may have other suitable thicknesses. As shown in FIG. 7, opposing end faces of the pipe segments 100 and 200 are covered with plastic liners 128, 228. The spigot 112 is engageable by the bell 210 to couple the pipe segments 100,200 together and to retain a first circumferential seal 130 between the end faces. In some embodiments, the seal 130 is a ½ inch medium medium density fibreboard (MDF) packer. Other suitable seals 130 may be used. One or more further seals 134 such as, for example, a block seal, may optionally be included in the joint assembly 150 and retained between the end faces. The seal created by the first circumferential seal 130 and, optionally, the further seal 134, enables fluid communication between fluid passageways 102 and 202 while preventing or minimizing escape of fluid from the joint.

As will be appreciated by a person skilled in the art, the joint assembly according to the present disclosure may facilitate and reduce cost of installation of plastic lined concrete pipe by obviating the need for welding the pipes together at each joint. Additionally, the joint assembly may be relatively simple to manufacture since a conventional bell and spigot mechanism may be used and the end face covers 128 and 228 can be plastic welded to the concrete of pipe end faces.

For simplicity and clarity of illustration, where considered appropriate, reference numerals may be repeated among the figures to indicate corresponding or analogous elements. In addition, numerous specific details are set forth in order to provide a thorough understanding of the examples described herein. However, it will be understood by those of ordinary skill in the art that the examples described herein may be practiced without these specific details. In other instances, well-known methods, procedures and components have not been described in detail so as not to obscure the examples described herein. Also, the description is not to be considered as limiting the scope of the examples described herein.

The examples and corresponding diagrams used herein are for illustrative purposes only. Different configurations and terminology can be used without departing from the principles expressed herein. For instance, components and modules can be added, deleted, modified, or arranged with differing connections without departing from these principles.

The steps or operations in the flow charts and diagrams described herein are just for example. There may be many variations to these steps or operations without departing from the principles discussed above. For instance, the steps may be performed in a differing order, or steps may be added, deleted, or modified.

Although the above principles have been described with reference to certain specific examples, various modifications thereof will be apparent to those skilled in the art as outlined in the appended claims.

1. A joint assembly for a plastic lined concrete pipe, the assembly comprising:
a first pipe having a first interior lining;
a second pipe having a second interior lining, the first and second interior linings being for conveying a fluid through the first and second pipes, respectively;
a first circumferential end cover provided on and at least partially covering an end face at a spigot end of the first pipe;
a second circumferential end cover provided on and at least partially covering an end face at a bell end of the second pipe;
a bell at the bell end;
a spigot at the spigot end; and
the spigot being engageable by the bell end to couple the spigot end to the bell end and to retain a first circumferential seal between the end faces.

2. The joint assembly of claim 1, wherein the end faces are perpendicular to longitudinal axes defined by their respective pipes.

3. The joint assembly of claim 2, further comprising a second circumferential seal sized to be provided between the end faces and having an inner diameter larger than an outer diameter of the first circumferential seal.

4. The joint assembly of claim 1, wherein the first and second circumferential end covers are made from a thermoplastic material.

5. The joint assembly of claim 1, wherein the first and second interior linings are made from a thermoplastic material.

6. The joint assembly of claim 1, wherein the first and second interior linings and the first and second circumferential end covers are made from a thermoplastic material.

7. The joint assembly of claim 6, wherein the thermoplastic material comprises high density polyethylene.

8. The joint assembly of claim 6, wherein the end covers are welded to the end faces.
